(19) United States
(12) Patent Application Publication
(10) Pub. No.: US 2014/0046818 A1
(43) Pub. Date: Feb. 13, 2014

(54) System and Method For Event Related Commerce Utilizing A Portable Electronic Device

(71) Applicants: Scott Lee Chung, Gardena, CA (US); Theodore Lee Chung, Los Angeles, CA (US)

(72) Inventors: Scott Lee Chung, Gardena, CA (US); Theodore Lee Chung, Los Angeles, CA (US)

(21) Appl. No.: 13/964,936

(22) Filed: Aug. 12, 2013

Related U.S. Application Data
(60) Provisional application No. 61/742,417, filed on Aug. 11, 2012.

(51) Int. Cl. G06Q 40/00

(52) U.S. Cl. CPC G06Q 40/00
USPC 705/35

(57) ABSTRACT

Commerce for event related products can be enhanced by utilizing a portable electronic device. Event related products can be goods or services that can be related to any type of event (i.e. sporting events, business events, shopping events, etc.). Commerce can be the marketing, buying, and selling of event related products. The enhancement of commerce can also mean an enhancement of an experience or an improvement of an event related product. Event related marketing, buying, and selling can occur before, during, and after an event utilizing a portable electronic device such as cell phone, tablet, pda (personal digital assistant), etc. Utilizing a portable electronic device can enhance the commerce experience related to the event including for the event itself.

### CROSS-REFERENCE TO RELATED APPLICATIONS

This application claims the benefit under 35 U.S.C. §119(e) of U.S. Provisional Application 61/742,417, System That Utilizes A Portable Electronic Device to Make An Event Related Purchase, filed Aug. 11, 2012, which is hereby incorporated herein by reference.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

1. Field of the Invention

The method and apparatus of the present invention relate to event related commerce using electronic networks such as the Internet or cellular networks. In particular, the present invention relates to a commerce model for marketing, buying, and selling of event related goods and services using the Internet or cellular networks. The commerce model includes possible enhancements made to a good or service that is related to the event.

2. Description of Related Art

While there are systems and methods for providing event-related incentives, such as U.S. Published Patent Application US 20120290336 A1, these incentives are based upon obtaining a ticket for an event and receiving a benefit due to the ticket. These methods and systems do not allow an enhancement of the event experience based upon an event related occurrence whether a user has a ticket or not. For instance, if a user is watching the event at home on television, there should be a way for a user to still receive an enhanced experience of the event even though the user is not physically at the event or is in possession of a ticket for the event. There are event related occurrences that can enhance the commerce for event related products for users that do not have tickets for an event. There is a need for a method or system to enhance the commerce for event related products for users that do not have event tickets or are not physically attending an event. While an event related occurrence can possibly trigger an affect on event related commerce, the possibility or chance of an event related outcome can also trigger an affect on event related commerce. The current system and methods that involve the chance of event outcomes typically are focused in gambling or wagering such as U.S. Published Patent Application US 20130005444 A1 and do not focus on how the chance of event related occurrence outcomes can affect event related products. There is a need for a method or system to enhance the commerce for event related products for users that is based on the chance or possibility of an event related occurrence happening.

There also methods and systems that integrate GPS or geolocation into the marketing of goods such as U.S. Published Patent Application WO 2001061671 A1. In addition, there are methods and systems that track shipped goods such as U.S. Pat. No. 8,280,682 B2. However the integration of user location can enhance the experience of the event itself and the marketing, buying, and selling of event related products. User location can be found not only through geolocation technology (i.e. GPS, wireless networks, etc.), but also through other information provided either directly or indirectly from the user. For example, user location can be found directly such as the user checking into a location utilizing a portable electronic device or manually sending information of past, current, or future location. The user location can also be transmitted indirectly such as utilizing the seat information of a user gained from the ticket that the user purchased for an event from a system that contains the seating information. There needs to be a method and system that allows other event and user information to provide location information for a user. In addition, there needs to be a method and system that utilizes user location to enhance event related commerce both for the user and the vendor.

There are various systems and methods for digital currency or virtual wallets, such as U.S. Published Patent Application US20120022981 A1, however they are not event focused to allow an enhanced experience of the event related product or for the marketing, buying, and selling of event related products. For example, these systems do not integrate user information and product information to create a more dynamic commerce experience. For instance, currency can be an event related product sold to a consumer and this event currency can have its own name that is specific to the event such as “Kodak Theatre® Cash”. The event currency can change value as the event occurs or depending on how it is used. Event currency can be restricted to be used for only certain goods or services at the event and be monitored to how the funds were used. It is possible that the event currency can be used for only one event, a recurring event, or multiple events. Event currency can change value when exchanged for other currency and used in currency trading in a currency market. A portable electronic device can be used to access a digital wallet, such as U.S. Published Patent Application US20020179704 A1, and user information can be involved with the portable electronic device for event related marketing, buying, and selling. For example, a user can set a budget for $40 of event currency to spend for food at an event and as the user arrives at an event the user can be sent time sensitive food options that can be bought for a reduced price that fit the users budget. There is need for a currency that is created for an event or events allowing for enhanced commerce that can benefit both a user and vendor.

### SUMMARY OF THE INVENTION

In one aspect, the invention includes a system and method that allows users to utilize their portable electronic devices to enhance event related experiences especially within the area of commerce. By utilizing a portable electronic device, the user can now have a more immediate and interactive commerce experience within the marketing, buying, and selling of event related goods and services including for the event itself.

In one embodiment, the invention, which may be implemented or embodied as a system, method, computer-readable media or a combination thereof, etc., is directed to a commerce environment enabling the marketing, buying, and selling of event related goods and services. The invention utilizes a user portable electronic device to transfer information to enhance the marketing, buying, and selling of event related goods and services. The event can be any type of event such as a sporting event, concert, performance, entertainment, movie, shopping, business, family, etc. While some aspects of this invention involve a ticket purchased for the event, not all aspects of this invention require tickets for an event. The marketing, buying, and selling of event related goods and services can be affected many ways such as an enhancement of the event experience, changes in price for event related good and services, etc.

In one aspect, information can either be sent to or received by the portable electronic device that is connected to a wireless network, such as a smart phone, PDA (personal digital assistant), etc. An event related occurrence can affect the marketing, buying, and selling of event related products, including the event itself, utilizing a portable electronic device. The event related occurrence can occur before, during, or after the event. For example, before a show starts a participant of the show can initiate a countdown that appears on a portable electronic device of a user who is experiencing the show either at the event or elsewhere. In another example, if a performer at a concert plays a sequence of notes, there could be a reaction by the portable electronic device such as a screen flashing or phone playing a sound. In an additional example, if a homerun is hit in a baseball game, the portable electronic device of individuals watching the game either in the stadium or at home can display a homerun animation and the device can vibrate. The event related occurrence could directly affect the sales offerings for event related goods and services. For example, after a musician performs a song, the live or recorded version of the song can be offered directly through a portable electronic device.

In another example, after a baseball player hits a homerun, the baseball player's jersey is offered for sale or even the bat used in the homerun can immediately be put up for auction. The event related occurrence does not have to be from participants of the event (i.e. staff, employees, etc.), the event related occurrence can be from an attendee of the event or an individual experiencing the event. For example, at a restaurant a patron can be informed of what others around the user has ordered. In another example, a donor at a fund raising event can automatically be registered in a sweepstakes or raffle for the event through a portable electronic device.

In another aspect, event related occurrences can cause event related notifications to be sent to the user that can be sent before, during, or after the event. For example users can be sent a notification to a portable electronic device on the best upcoming window of time to use the restroom during a Broadway play based upon when certain acts or indicators are reached during the play. It is possible that a ticket, location, or property is leased or rented for an event and the user can be notified about information concerning the lease or rent. For example, a specific seat in a football game can be leased to an attendee for a set time during the game. After leasing the seat, the attendee can be notified about the time left on the leased seat through a portable electronic device. It is possible the attendee can buy more time for the seat or outright buy the seat for the remainder of the game through a portable electronic device.

In another aspect, an event related occurrence can change the probability of the possible outcome of an event related occurrence that can affect the marketing, buying, and selling of event related goods and services. An event related occurrence can change the likelihood of an outcome that can affect the marketing, buying, and selling of event related goods and services. For example, if a Nascar® driver is in last place in a race, the chances of winning are minimal and therefore the price for merchandise for the last place Nascar® driver can be lowered and the new low price can be notified to users via a portable electronic device even before the race is over. The probability of the possible outcome of an event related occurrence is different than a completed event related occurrence affecting the marketing, buying, and selling of event related goods and services. In the above Nascar® example, a completed event related occurrence that affects buying and selling of event related goods and services is the price of the driver's merchandise being dependent upon the exact position in the race that the driver is in. For instance, if the driver is in third place and then passes the next car in front of him/her to be in second place, the price of merchandise for the driver can rise to match the current place that the driver is in. The actual occurrence is the passing of another car and the effect is the rise in price for the driver's merchandise. The probability of the possible outcome of an event related occurrence is based upon the prediction of an event related occurrence. This prediction can be very precise such as by giving an exact percentage chance of an outcome for an event related occurrence or can be general such as an estimate of what the possible outcome is. The possible outcomes for an event related occurrence can be the final outcomes for the entire event (i.e. winner of a boxing match, 1^{st} place of a tournament, etc.), it can be for parts of an event (i.e. the first act of a play with four acts, the first ten minutes of a golf match, etc.), or it can be outcomes that are connected to the event (the chance of a team winning the next game due to the results of the current game (event), the critics ratings for a movie, etc.)

In another aspect, information can either be sent to or received by the portable electronic device that is connected to a wireless network, such as a smart phone, PDA (personal digital assistant), etc. Information can be manually input or output or automatically input or output via a portable electronic device. The transferred information can be used to create a result from embodiments of this invention and also be the results of the invention. For example, the location of a user can be known through the seating assigned for an event and the user's portable electronic device can output visual or audio information depending upon where the user's assigned or seated location is during the event. The location of the user can be determined based upon where other users are, such as utilizing the portable electronic device of the user and comparing that to where other user portable electronic devices are. For instance, a crowd assembled picture can be created by attendees all holding up their portable electronic devices that each are displaying a piece of the picture. Each piece of the picture is in the proper location to assemble the larger picture by knowing the location of each user device relative to each other.

In another aspect, geolocation through a portable electronic device can be used to find the user's location. Geolocation can be found through a single or mixture of technology such as GPS, proximity from networks, APIs (i.e Foursquare, Google Maps, etc.). Geolocation can be used for marketing of event related goods and services, such as by informing users where nearby authorized vendors are either inside or outside the event. Users can use their portable electronic device to search for an event related specific good or service and the device can inform them of nearby authorized vendors that offer the good or service. Discounts can be offered based upon where a user is located, such as if a user is located far from the vendor, the vendor can send a discount to the user to entice them to come to the vendor. There can be rules for sales that can be affected by location, such as a refund will only be given if the user remains within a location and once the user leaves a location the refund will no longer be accepted.

In another aspect, user location can enhance the commerce experience and create more options for users. Knowing the user's location can be utilized to help prepare goods or services or deliver goods and services. For instance, a kitchen can begin cooking when a certain amount of users are within a certain distance to keep the food fresh for consumers. An event attendee can receive a message alerting to pick up goods or services when they are headed to an exit of the event or when they pass by a set location. The delivery method of a good or service can change, such as if the attendee leaves the event and does not receive the good or service, the user can receive a notification on a personal electronic device giving them the option to now have the goods or service delivered to an address. The location of user can affect the delivery of goods or services as they can now be delivered directly to a vehicle or directly to an event attendee when entering, attending, or departing the show by utilizing a portable electronic device. For example, a good or service can be purchased online by an individual that is not at the event, and the good or service can be delivered directly to an attendee at the event for gifting, availability, or delivery reasons.

In another aspect, a portable electronic device can act as virtual wallet that can be the utilized in marketing, buying, and selling of event related goods and services. A portable electronic device can be utilized to budget currency utilized for event related goods and services. It is possible that every time an event related good or service is purchased or refunded the budget is automatically updated to reflect new transactions. The budget can be updated by the portable electronic device being utilized in the transaction process, the portable electronic device updated via a network, or the user updating the budget manually on the portable electronic device. This budget can be administrated by a third party with all aspects of the budget being controlled by this third party. Reports of how the event budget was spent can be created that can be presented in various formats such as product category, location, etc. For example a budget of $200 can be created for a visit to Disneyland® and the report can show that the ticket cost $75, food was $45, merchandise was $50, and transportation to the park was $30. If vendors or event administrators have access to the users budget for an event, it could show the purchasing history for each user allowing for more targeted marketing before, during, or after the event.

While the budget can just be an accounting tool for an event, it could also be a used as a currency that is related to the event. For example, the Coachella Music Festival® could have its own currency called Coachella Cash that can be used for at any authorized vendors for the event either inside or outside of the event including online. Events where another party receives a percentage of sales from vendors would benefit from a system that utilizes virtual currency as opposed to tickets, cards, or any other physical substitution for currency. If the event utilizes event currency it is possible that an administrator of the system can know where all the event currency was spent and who owns what amount of event currency at any given time. This system could show the amount of event currency each user has allowing for more targeted marketing to users. It is possible that a user's event currency account is controlled by a third party that has the ability to restrict currency usage by vendor, good, or service such as not allowing currency to be used for alcohol, cigarettes, etc. or not allowing the currency to be utilized for certain vendors, product types, or product groups such as online vendors, Starbucks®, fast food, etc. The third party can even freeze the account, deduct from the account, add funds to the account, etc. Refunds or changes in price for event related goods and services can be given in event currency, even if the goods or services were originally purchased in traditional methods (U.S. Dollars, credit card, etc.)

Event currency allows new forms of transactions to occur including for the event currency itself. For example, a user can receive a discount by purchasing event currency in bulk or by purchasing before a specific date/time. There can be bonuses or rewards for event currency for more event currency, exclusive discounts, or exclusive goods/services. Bonuses or rewards can be obtained via how event currency is spent, is gained, or is maintained. For example, by spending a minimum amount online for event related goods a user can receive a bonus upgrade for an event ticket such as a seat closer to the stage. It is possible that event currency can change value depending upon time, location, or usage. Such as the event currency can have more purchasing power if a user spends at least a set amount within a set time frame or the event currency can depreciate during halftime at a game so it detracts a rush of consumers all at once to vendors. Refunds involving event currency can change the refunded value, ability to refund, or ability to purchase for a user. For example, the amount of refunded value that a user can receive from a purchase can depreciate over time or if too many items are refunded the entire account can be blacklisted by the vendor.

Event currency can range from being exclusively used at one event by the user that purchased the event currency to being used at multiple events and transferred freely amongst users. It is possible that users can give event currency to one another via a portable electronic device or even exchange event currency to another currency (i.e. other event currency, U.S. Dollar, etc.). Event currency can be changed to another currency for a fee or for a difference in value for each amount of currency similar to a currency market. For example, the event currency could be changed into U.S. Dollars for a fee before the event is over and after the event the fee could be removed. Or the promoters of the event could make a deal with another event promoter that the funds can be transferred to the other event, but the promoters will need a straight fee or a fee based upon a percentage of funds transferred to the new event currency. Events could also be somehow related and users are able to transfer funds with no fees or rate changes between these events. These related events could all use one type of currency due to the parties involved such as a promotion company, event production company, or a venue. Each of these entities can throw multiple events that can have the same currency or accept each other's event currency. Event currency can also be themed such as by genre, so all event related goods and services offered that are related to a specific theme can be purchased with the themed event currency. Event currency can also be participant focused so that goods and services related to a specific event participant can be purchased utilizing the event currency. For example, for a Bruce Springsteen® concert, event currency can be purchased that can be used for any Bruce Springsteen related good or service.

Combinations of occurrence, user location, and event currency can be utilized to come up with various ways to affect marketing, buying, and selling of event related goods and services. For example, a portable electronic device can be utilized to assume that a ticket holder is not at the event after the event has started by utilizing the current geolocation of the device and the current time and comparing them to the event location and event start time. This could automatically notify the user that the event has started and can ask the user if the user would like to sell or lease his/her ticket due to them not being present at the event. An example of user location and event currency affecting the marketing, buying, or selling of event related products is monitoring the location and event currency that each user has at an event. Targeted marketing can be sent specifically to each user depending upon which vendor that they are passing through geolocation. This targeted marketing can be further refined by knowing the user's transaction history and current balance of event currency that they have so that only goods and services that they have shown interest in or can afford are offered to them.

In the following description, reference is made to the accompanying drawings which form a part hereof and which illustrate various embodiments of the present invention. It is understood that other embodiments may be utilized and structural and operational changes may be made without departing from the scope of the present invention. The invention may be applied as a system and method, as hardware or software, or any combination thereof. For ease of reference the invention or parts of the invention are referred to or illustrated in figures as an application program, however this in no way limits the system and method to just an application program.

### BRIEF DESCRIPTION OF THE DRAWINGS

FIG. 1 illustrates an embodiment of a network computing environment in which the invention may be implemented;

FIG. 2 illustrates an embodiment of a computing environment of a server in accordance with the invention;

FIG. 3 illustrates an embodiment of files in a user record and a product record in accordance with the invention;

FIG. 4 illustrates an embodiment of a program flow implemented on the server to allow the user to register for Basic Registration in accordance with the invention;

FIG. 5 illustrates an embodiment of a program flow implementation on the server to allow the user to register for Full Registration in accordance with the invention;

FIG. 6 illustrates an embodiment of the invention as a mobile phone application used at an entertainment event;

FIG. 7 illustrates the program logic implemented when an event related occurrence is received;

FIG. 8 illustrates the program logic implemented when an event related occurrence is received;

FIG. 9 illustrates an embodiment of the invention as a mobile phone application used at a sporting event;

FIG. 10 illustrates the program logic implemented when a user location is received;

FIG. 11 illustrates an embodiment of the invention utilizing event related occurrence, user location, and event currency to show user location over a layout/map of the event and the relevant user current condition or status;

### DETAILED DESCRIPTION OF THE INVENTION

In the following detailed description of the invention, reference is made to the figures, which illustrate exemplary specific embodiments of the invention. It should be understood that varied or additional embodiments having different structures or methods of operation might be used without departing from the scope and spirit of the disclosure.

In one embodiment, the invention, which may be implemented or embodied as a system, method, computer-readable media or a combination thereof, etc., is directed to a commerce environment enabling users to enhance event related goods and services. This enhancement can be of the good and service itself or it can be for the marketing, buying, and selling for event related goods and services. The enhancement is achieved by utilizing a portable electronic device that can allow the user to receive or send information via the device. The invention can be applied to past, current, and/or future events.

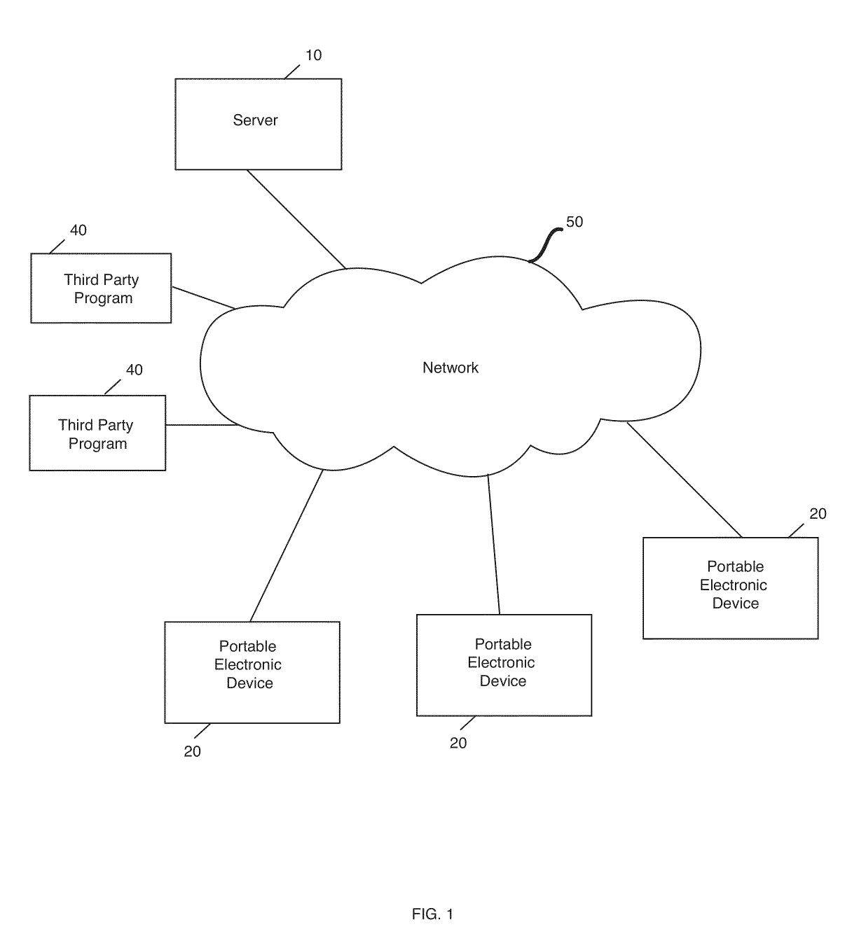

FIG. 1 is a schematic overview diagram of an exemplary network computing environment in which the invention may be implemented. In one embodiment, a server 10, portable electronic devices 20, and third party programs 30, are linked together in communication by a network 50, such as the Internet. The network 50 may be comprised of any network system known in the art including TCP/IP based networks (e.g. an Intranet, the Internet), LAN, Ethernet, WAN, Token Ring, Cellular, etc. Alternatively, there may be separate and different networks between the components. Further, because in this embodiment, the network 50 is the Internet, there can be numerous parties using the network 50 simultaneously, although only three portable electronic devices 20 and two third party programs 40 are shown for illustration purposes. In addition, portable electronic devices 20 can vary from user portable electronic devices (i.e. smart phones, cell phones, cameras, camcorders, tablets, laptops, etc.) to borrowed electronic devices given to the user (i.e. rental equipment, leased devices, event devices, venue devices, etc.). Third party programs 40 are programs that may be outside the system of the invention, but may be utilized to access information that is utilized by the system of the invention (i.e. Application Programming Interface “API”, search engines, media host services, etc.).

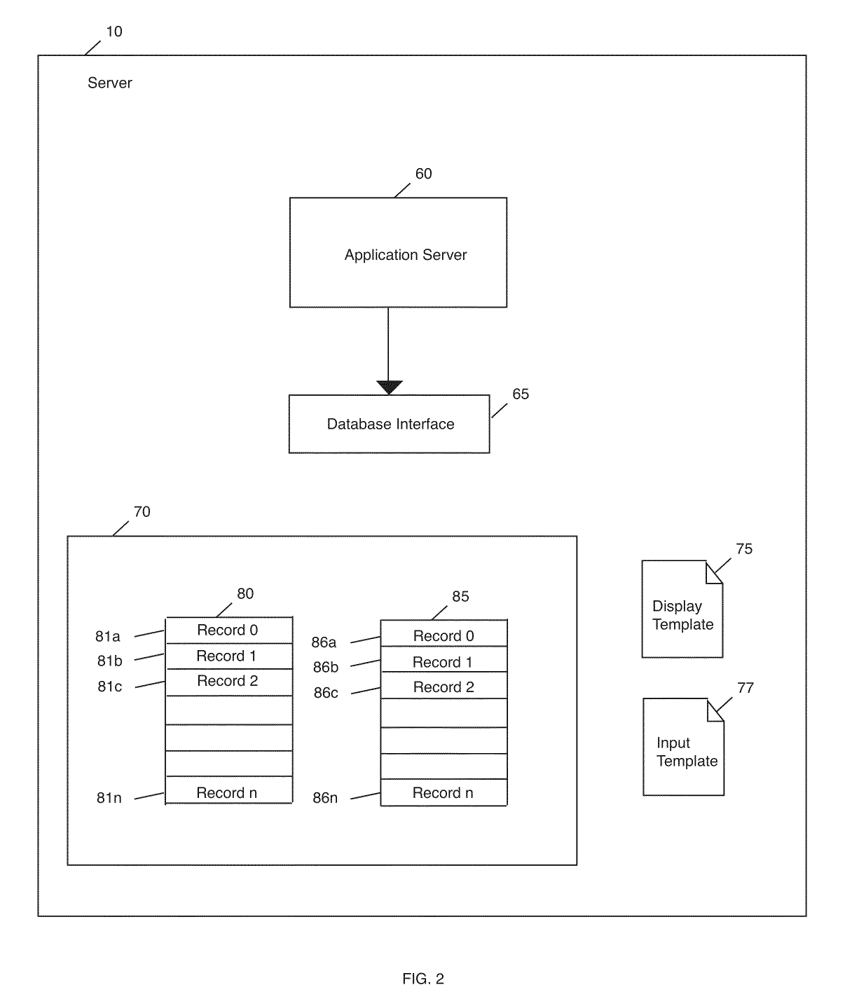

In accordance with an embodiment of the invention, FIG. 2 illustrates components including server 10, including an application server 60, database 70, database interface 65 and templates 75 and 77. The application server 60 responds to requests from the portable electronic devices 20, using an application client program, such as web browser programs (HTTP client programs) or any client based programs known in the art. Upon accessing the application server 60 through the network 50 using a network address, such as an IP address, the database interface 65 will give specific access to database 70 depending on the secured identification provided by the portable electronic devices (i.e. unique username and password).

The database 70 keeps current, accurate information about the users and creating and updating products in the commerce process. The database 70 comprises of a database program known in the art, such as a relational database program. In one embodiment, the database 70 includes two database tables, user database table 80 and product database table 85. User database table 80 includes user records 81a, b, . . . n that may be used in to track user information. Product database table 85 includes product records 86a, b, . . . n which is used to track event related products.

The database interface 65 may comprise a Common Gateway Interface (CGI) program, a Java servlet, or other programmable implementation known in the art to present information in database 70 in a presentable format (e.g. HTML page, etc.). In one embodiment, the database interface 65 uses a secure login/password verification for identifying the individual user contacting the Application server 60. The assigning of a secured login/password is explained in greater detail herein. The unique identification will allow the database interface 65 to identify which user record 81a, b, n belong to the requesting party and will appropriately give read/write capabilities to the user record 81a, b, . . . n.

The server 10 further stores a display template 75 and an input template 77, which are preferably implemented in a document in which dynamic content may be generated (i.e. HTML, Extended Markup Language (XML) Document, etc.). Differing variations of the display template 75 and input template 77 exist for both user information and for product information, depending on the information to be displayed or inputted, but a single display template 75 and a single input template 77 are used for illustration purposes in FIG. 2. The display template 75 is used to provide the portable electronic devices 20 with specific user information from the database table 80 or specific product information from the database table 85. The database interface 65 generates data into the display template 75 from one or more of the records 81a, b, . . . n and 86a, b, . . . n in the database 70. The input template 77 includes fields in which the user may enter information to update the user record 81a, b, . . . or n, as well as update the product record 86a, b, . . . n when a user interacts with a event related product.

The database 70, display template 75, and input template 77 are preferably stored in a non-volatile storage system, such as one or more hard disk drives, used by the server 10 for storage. The server 10 may load data from the storage system into volatile memory (not shown) when processing. Data can also be saved off the server with links or directions where the data is located on the network 50 (i.e. cloud storage, media hosted by other platforms, information from user accounts on other platforms, etc.), however for illustration purposes the data is depicted as being saved on the server 10.

The server 10 and portable electronic devices 20 may comprise any type of computer device known in the art, including server, personal computer, mainframe, workstation, hand held device, etc. Moreover, the server 10 may comprise one or more separate computer systems to run the different program components 60, 65, and 70. A user is an individual, group, or entity that is directly utilizing the invention for commerce purposes.

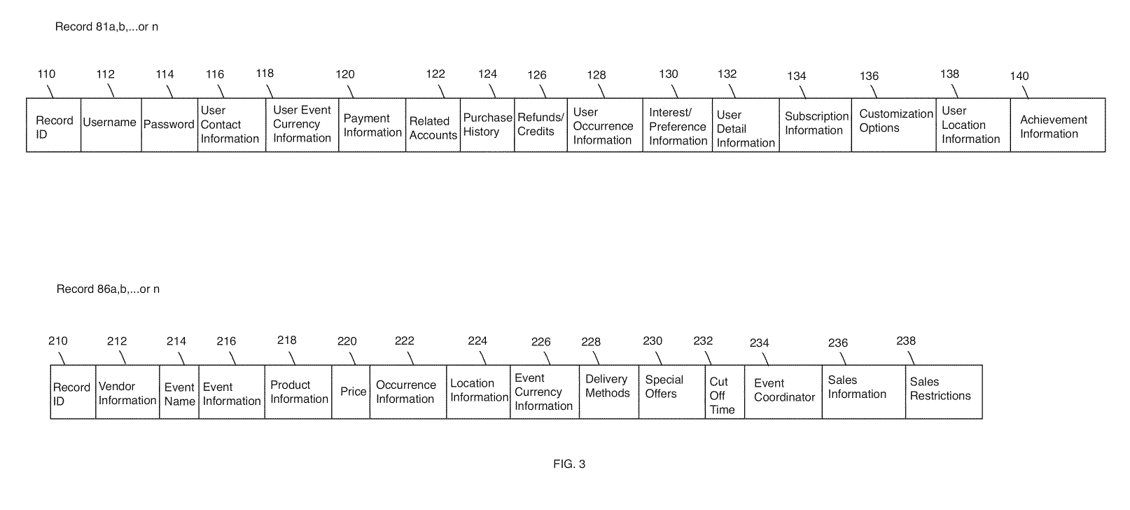

FIG. 3 provides an implementation of the fields in the user records 81a, b, . . . n, which include:

Record ID 110: Provides a unique identifier generated by the database interface 65 for each unique user.

Username 112: Provides a unique username that the user uses to access the user account and account related information.

Password 114: Provides a secret password created by the user used in conjunction with the username in order to access the user account and account related information.

User Contact Information 116: Provides an email address of user, phone number, address, chat id, delivery address, and other contact information.

User Event Currency Information 118: Comprises of one or more sub-fields that contain the account balance, transaction history, and information concerning event currency.

Payment Information 120: Comprises one or more subfields indicating payment information (i.e. Paypal, Bitcoin, credit card info, etc.) other than Event Currency.

Related Accounts 122: Comprises of one or more sub-fields that contain the username and passwords to other accounts online to be used to send information to or gather information from.

Purchase History 124: One or more sub-fields set by the database interface 65 containing the purchase history of event related goods and services.

Refunds/Credits 126: One or more sub-fields set by the database interface 65 containing refund history for event related goods and services or information concerning credit given to the user.

User Occurrence Information 128: One or more sub-fields set by the database interface 65 indicating all event related occurrences that the user is anticipating or has experienced, instructions, and affects of the occurrence.

Interest/Preference Information 130: One or more subfields set by database interface 65 providing history about the user including preferred media, events, etc. and the interests and preferences listed by the user during the Full Registration process or assumed by the system through user activity.

User Detail Information 132: One or more subfields indicating whether the user has account restrictions, type of user (i.e. individual, group, business, entity, etc.), profile details, etc.

Subscription Information 134: Comprises of one or more sub-fields that contain the location/area, username, event, or keyword that the user will receive information on.

Customization Options 136: Comprises one or more sub-fields recording customization options for a user account such as notifications, presentation of information, etc.

User Location Information 138: One or more subfields set by database interface 65 providing information regarding the users current and past locations. Also contains information on locations that affect users (i.e. enhancement of a event related product, marketing of a event related product, price of a event related product, availability of a event related product, etc.)

Achievement Information 138: One or more subfields set by database interface 65 providing information regarding the goal and achievement information for any event related product related to the user.

FIG. 3 also provides an implementation of the fields in the event related product records 86a, b, . . . n, which include:

Record ID 210: Provides a unique identifier generated by the database interface 65 for the each event related good or service.

Vendor Information 212: Provides information about the vendor such as name, location, contact information, etc.

Event Name 214: Provides an identifier name for the event the good or service is offered for

Event Information 216: Provides information about the event such as genre, date, duration, individuals involved, etc.

Product Information 218: Provides information on the good or service such as name, description, stock, exclusivity, etc.

Price 220: Provides information about the price of the product offered and any alternate offered price due to event related occurrences, user location, event currency, special deal, etc.

Occurrence Information 222: Provides information on the affect that event related occurrences have on the product offered (i.e. enhancement of the good or service, marketing, price, availability, etc.) such as instructions if the event related occurrence occurs

Location Information 224: Provides information on the affect that location has on the product offered (i.e. enhancement of the good or service, marketing, price, availability, etc.) such as the effect on the offering if the user is located in a specific area or region.

Event Currency Information 226: Provides information on the affect that event currency has on the product offered (i.e. enhancement of the good or service, marketing, price, availability, etc.) such as the amount of event currency a user has.

Delivery Methods 228: Provides information about the possible delivery options for the event related product.

Special Offers 230: Provides information about any special offers being given for the event related product such as package deals, discounts, coupons, etc.

Cutoff Time 232: Provides the set date and time when the product will no longer be offered

Event Coordinator 234: Provides information about the event coordinator for the event or individual or entity overseeing the vendor at the event and any information that the event coordinator has set for the event such as event rules, vendor obligations, etc.

Sales Information 236: Provides a history of transactions in regards to the event related product including any changes made to any orders

Sales Restrictions 240: Provides any sales or refund restriction information for the offered event related product

Those skilled in the art will appreciate that FIG. 3 illustrates an embodiment of the records 81a, b, . . . n, and 86a, b, . . . n but not the only implementation. The database tables 80 and 85 can be structured in many alternative formats to accomplish the present invention.

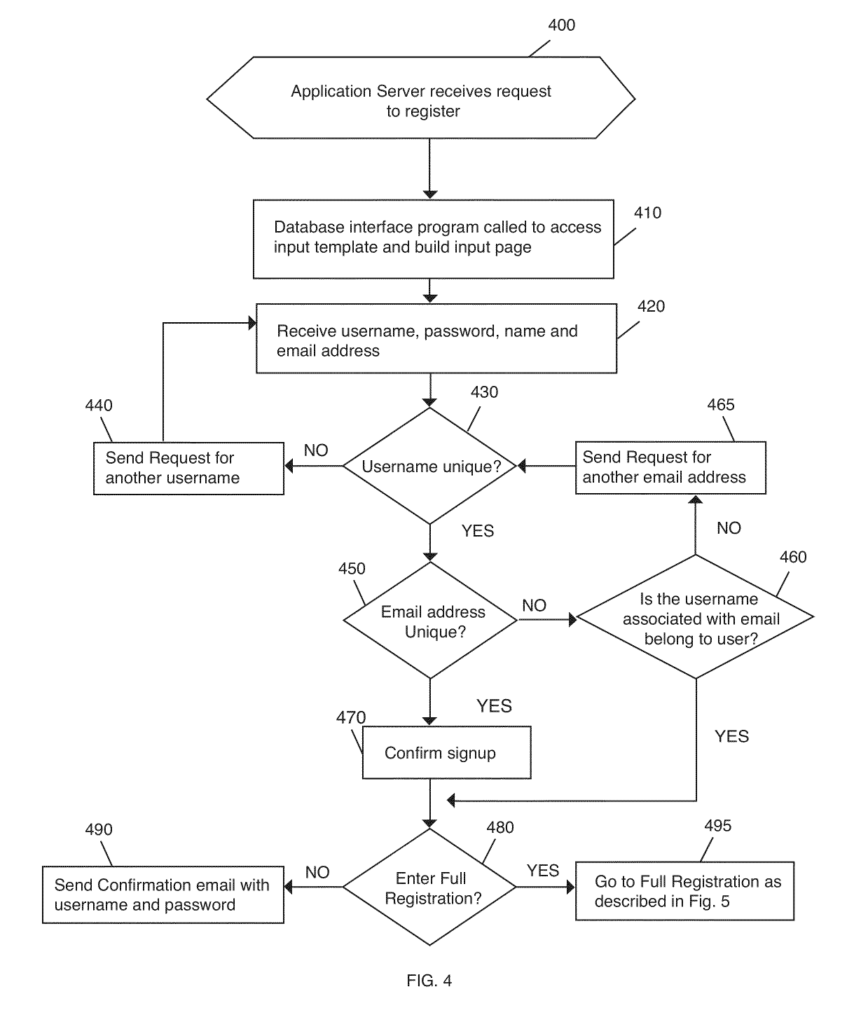

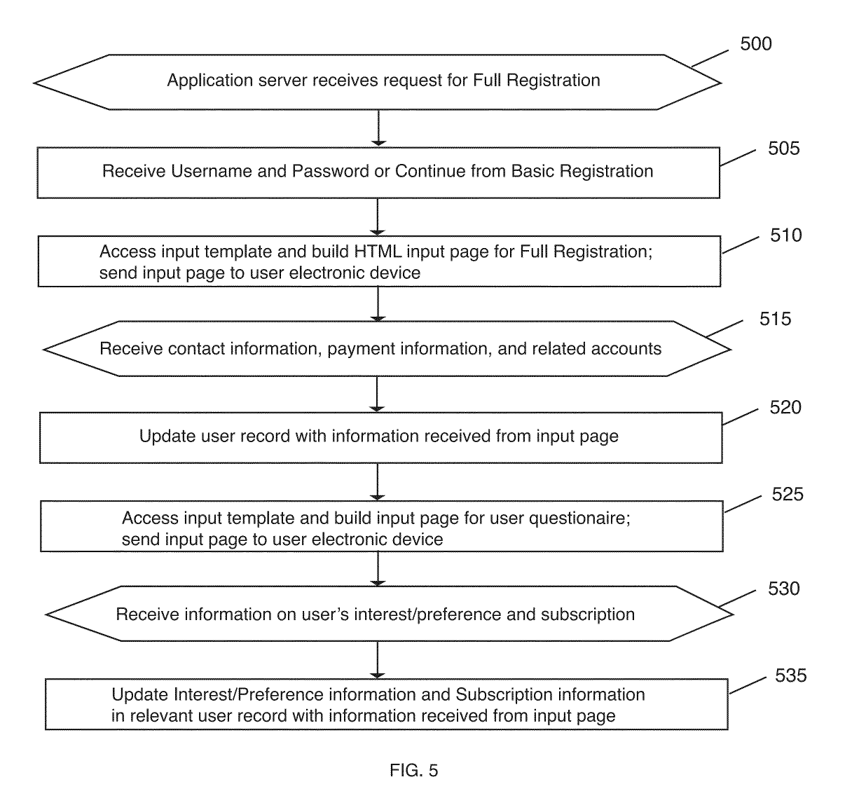

Typically the application process starts when a program is installed on a portable electronic device 20 that allows it to communicate with the server 10. This program allows users to create products and replies to products. Each user will need to be registered in order to utilize the program, which can be done through the Basic and Full user registration process. In addition, users can register by using login information already created on different systems/platforms through third party programs 40. API's such as Facebook Login, allow users to use existing user account information and content that is associated with those third party accounts. User login information using accepted third party programs 40 can be used to create new user accounts. Once verified, third party user account information can create a new user record 81a, b, . . . or n. In addition, additional user information can be accessed from these third party accounts to create more comprehensive user profile that is alternatively gained through the Full Registration process. The creation of a user community through the Basic and Full Registration process to build the user database table 80 for the program will be explained in conjunction with FIG. 4 and FIG. 5.

FIGS. 4, 5, 7, 8, and 10 illustrate embodiments of the program logic embedded in the application server 60 and the database interface 65 to implement the communication process of the invention. FIG. 4 illustrates the program logic to establish a unique user record 81a, b, . . . n with basic user information (“Basic Registration”). At block 400, the application server 60 receives a request to register. At block 410, the database interface 65 accesses the input template 77 and builds another input page querying the user to input username, password, and e-mail (at block 420) and places the information in a new user record 81a, b, . . . or n the database interface 65 then checks the database table 80 to see if the username is unique (at block 430). If the username is already in use by another user record 80a, b, . . . or n, then at block 440 the database interface 65 accesses the input template 77 and builds an input page requesting the user to input another user name. The process is repeated until a unique username is assigned. At block 450, the email address is checked to see if the email entered is unique. If the email address is already in use by another user record 80a, b, . . . or n, then at block 460 the database interface 65 accesses the input template 77 and builds an input page stating that the email address is associated with an existing username, and the user is asked to confirm whether the username belongs to the user by asking for the password associated with the specific user record 81a, b, . . . or n. If the correct password is inputted, the prior user record is used and the new user record deleted. If not, then at block 465 the user is queried to input another email address. The process is repeated until a unique email is assigned to the user record 81a, b, . . . or n. At block 470, an email message is sent by the server 10 to confirm the signup by the user. Upon receiving confirmation via email or hypertext link to the confirmation page (not shown), the user will be given an option for Full Registration. If no confirmation is received within a set amount of time, the newly created user record will be deleted. At block 480, the database interface 65 will build a display page based on display template 75 which will list the benefits of full registration. Benefits of full registration may include creation of public products, higher prioritization of media replies, etc. If the user decides not to signup for full registration, server 10 sends a confirmation email to user using the User Contact Information 116 associated with the user record 81a, b, . . . or n stating the Username 112 and Password 114 associated with the user record 81a, b, . . . or n. If the Full Registration option is selected, the logic of FIG. 5 is implemented from block 505.

FIG. 5 illustrates the program logic implemented in the application server 60 and the database interface 65 to enter additional information into the user record 81a, b, . . . or n for Full Registration. In order to sign up for Full Registration, a user must have already completed the Basic Registration process having a unique username and password or have utilized a verified third party API login. At block 500, once the user has completed the Basic Registration process, the user will be given the option of Full Registration. At block 505, the application server 60 receives a request from the user for the input page to convert the user record 81a, b, . . . n from Basic Registration to Full Registration. In response, the application server 60 requests (at block 510) the database interface 65, which accesses the input template 77 and builds an input page for the specified user record 81a, b, . . . n. The built input page is then sent to the portable electronic device 20, where the user can enter contact list information, payment information, and third party login information for an accepted third party API login. At block 515, the application server 60 receives the input page with the user contact information, interest/preference information, payment information, and third party login information. In response, the application server 60 requests the database interface 65 to update (at block 520) the User Contact Information 116, Payment Information 120, and Related Accounts 122 of the relevant user record with the information supplied by the user. Also if the user provides third party login information, then the third party account may have information that can be automatically imported into the relevant user field such as Interest/preferences, contact information, etc.

In one embodiment, the Full Registration process also includes collecting additional information from the user regarding the user's interests/preferences and subscriptions. By receiving the user's interests/preferences more relevant content can by directed towards users such as type of events that align with the user's interests (i.e. rock concerts, plays, etc.) or users of similar interests/preferences. Also a user can directly subscribe to a location (i.e. venue, city, etc.), individual (i.e. celebrity, friend, etc.), or any keyword (i.e. Coca Cola, Boy Scouts, etc.) to be notified when activity is occurring that is relevant to what they have subscribed to. After receiving the preference information inputted by the user at block 530, the application server 60 requests the database interface 65 to update (at block 535) the Interest/Preference Information 130 and Subscription Information 134 of the relevant record with the information supplied by the user.

In one embodiment, a user can lift restrictions from their account by having the third party login verified through a third party program 40, submitting verified payment information, or the user database receiving certain user information through user interest/preferences. One of these processes, a combination of these processes, or parts of each process can be used together to lift restrictions on accounts. Once information is verified, the User Detail Information 132 is updated to lift certain restrictions for the specified user record such as the restrictions lifted off of an account with only Basic Registration. The additional user information that is gained from Full Registration does not need to be immediately input after a user record has been created. Users can add or change information within their existing account at a future time. As their user activity is recorded in Interest/Preference Information 130, the system is constantly updating the user record with more user information without direct user input. As user activity contributes to user information, it may be possible to release restrictions for an account record by completing certain actions within the program. In addition, additional information can be added to the user account without the user manually entering information, by the program automatically importing information from third party programs 40 (i.e. Facebook API, Paypal API, etc.) with their provided third party login information.

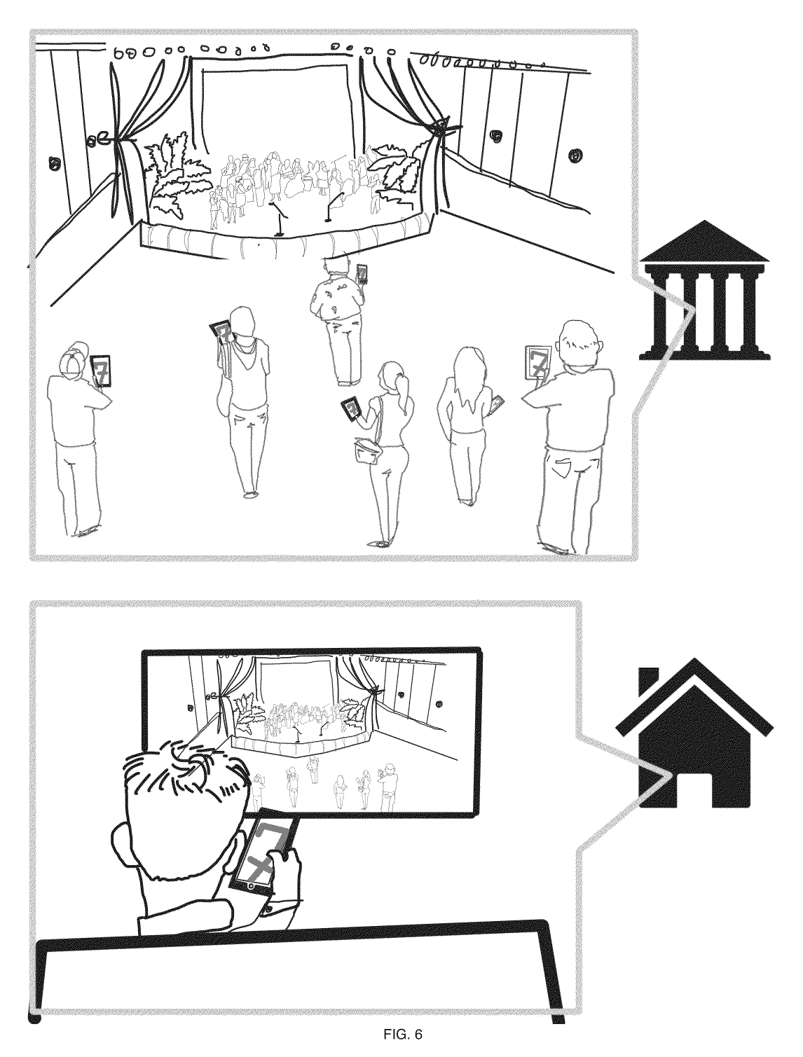

FIG. 6 is an illustration of an embodiment of the invention as a mobile phone application used at an entertainment event. As stated earlier, the provided figures of the invention as a mobile phone application are for illustrative purposes only and do no limit this invention to a mobile phone application. FIG. 6 shows two locations, one that is at the venue with attendees holding their portable mobile devices and the other is at a home of a viewer watching the performance on live television. The performance is about to start and a countdown is sent to the portable electronic devices of users regardless if they are at physically at the performance or not. This creates an interactive experience regardless of the location of the user and does not require the user to purchase an event ticket. In the figure, the countdown can represent each second to the beginning of the show and can start from 10 and end at 0, however it is currently shown to be on 7 on user portable electronic devices. Any type of media, information, or interaction can occur with the portable electronic devices such as lights appearing on the screen that are flashing to a beat, vibration of the devices during certain thematic moments of an event (i.e. a scary moment of a film), etc. All the various actions or interaction that can happen with the portable electronic device are caused by specific event related occurrences. For example, a participant in the performance such as an engineer backstage can cause the countdown to occur by directly inputting into a system that the countdown should begin.

Event related occurrences that can affect the user are input into the user database 80 in field User Occurrence Information 128 for the relevant user record. User Occurrence Information 128 contains information about event related occurrences that the user is anticipating or has experienced. User Occurrence Information 128 can be from event related products that the user has purchased or shown interest in or from user Interest/Preference Information 130. The User Occurrence Information 128 obtained from event related products is gathered from the product database 85 in field Occurrence Information 222. Vendors that create new product records in product database 85 can input Occurrence Information 222 at the time the new record is created or after the new record is created. Occurrence Information 222 contains the information of what occurrence triggers set instructions to be executed. The occurrence can be triggered by participants of the event (i.e. stage crew, performers, etc.) or by attendees of the event (audience, viewers, etc.). For example, the countdown displayed on portable electronic devices shown in FIG. 6 can be started when enough attendees enter an event. Whether the occurrence has happened can be directly input into a system or a system can monitor and determine whether the occurrence has happened or not. For instance, a direct input into a system could be a disc jockey can have equipment connected to an audio output in addition to this system. When a button on the equipment is pushed, an audio response occurs along with a signal that the occurrence has happened that cues a visual response from everyone's portable electronic device. An example of a system determining whether an occurrence has happened or not is an occurrence that is based on a sequence of notes being played and audio sensory devices can be setup along with an audio program to determine if the sequence of notes have been played or not. There are many devices that can participate in either directly inputting that an occurrence has happened or determining whether an occurrence has happened from sensory devices (i.e visual, audio, etc.), counting devices, manual input buttons, etc.

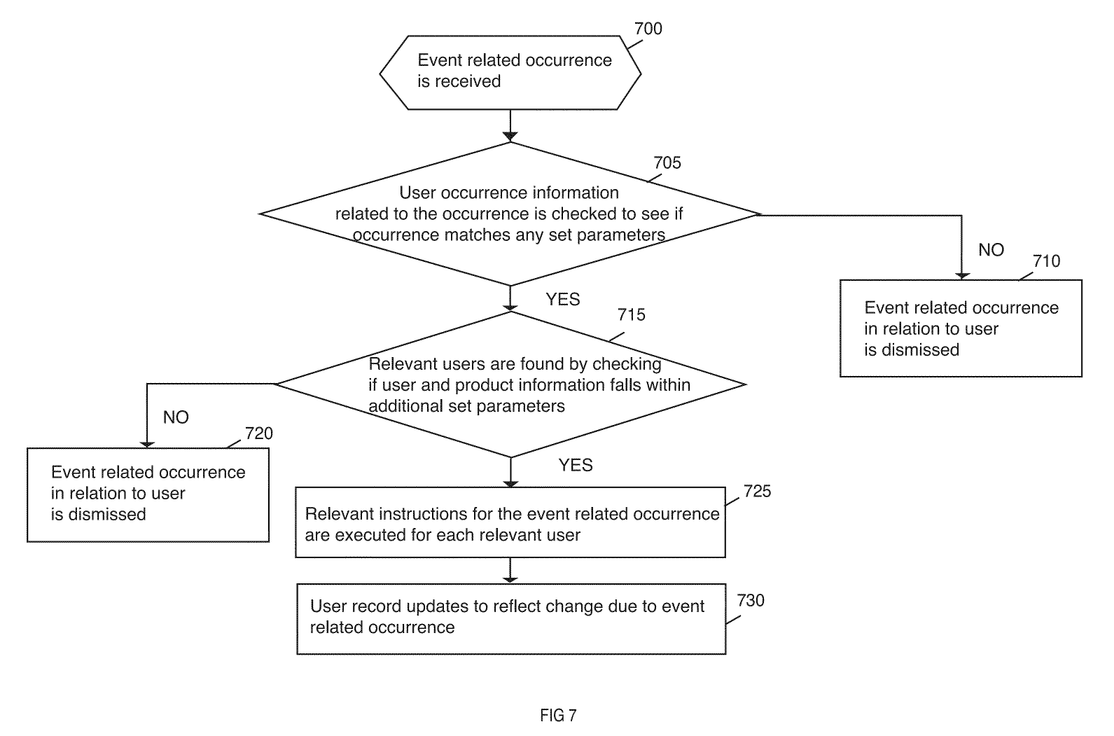

FIG. 7 illustrates the program logic implemented when an event related occurrence is received. Block 700 shows that an event related occurrence is received, which can be from either the direct input that an occurrence has happened or a system that determines an occurrence has happened that transmits a signal communicating the occurrence has happened. At block 705, the User Occurrence Information 128 from user database 80 that is related to the occurrence is checked to see if the occurrence matches any set parameters in the User Occurrence Information 128. For instance, all because an event related occurrence is given to the system, does not mean that the occurrence necessarily causes any affect to occur. So if a sequence of notes is played and the occurrence is sent to the system, the sequence of notes could not be the right sequence of notes that causes an affect. If the occurrence parameters are not met, then block 710 occurs where the event related occurrence in relation to the user is dismissed.

If the occurrence meets set parameters for one of the occurrences set for the event, block 715 occurs where relevant users are found by checking any additional parameters set in the relevant occurrence found in User Occurrence Information 128 against the relevant user and/or product record. The information utilized for additional parameters can be from the user database 80 or product database 85. For instance, it is possible that if the User Location Information 138 shows that the user is no longer at the event, then the user will not be considered a relevant user and will not receive the countdown shown in FIG. 6. Also the product record can contain information that can determine whether relevant users exist, such as if the occurrence causes a decrease in price for a product however there is not stock left found in product database 85 in field Product Information 218, no marketing notification will be sent to users as there is no stock left for the product. The relevant users are the users that will be directly affected by the event related occurrence, as it is possible for an event related occurrence to only affect a subset of users.

Once the relevant users are found, the relevant instructions for the event related occurrence are executed as shown in block 725. The instructions, programs, and devices do not need to exist or be executed by the system. The system can point to where instructions exist or utilize other programs and devices to carry out occurrence instructions. Within the system, the instructions for the occurrence can affect the user record in user database 80, the product database 85, or directly transmit information to the portable electronic devices of users. In step 730, the executed instruction affect the information in user database 80 field User Occurrence Information 128, by maintaining a history of what instructions were executed and what was affected. There are various instructions that can be executed from changing a price of an event related good and notifying select users of the change in price to notifying users of expiring leased seats that they may be possibly interested in.

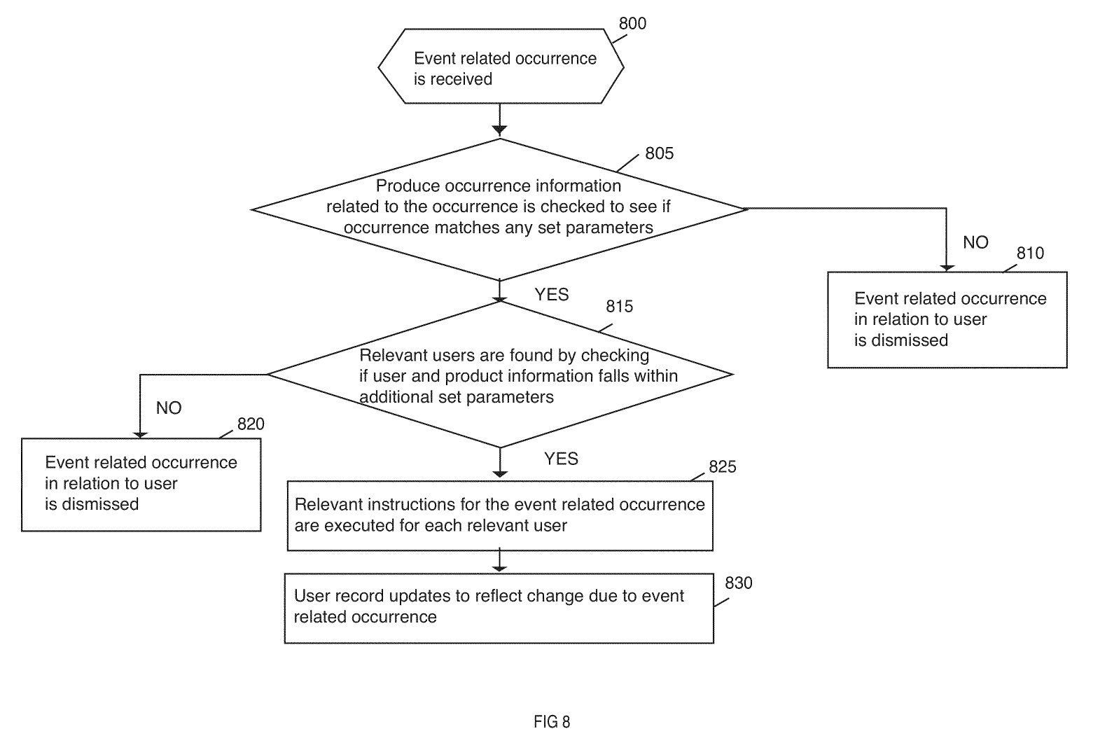

FIG. 8 illustrates the program logic implemented when an event related occurrence is received. Block 800 shows that an event related occurrence is received, which can be from either the direct input that an occurrence has happened or a system that determines an occurrence has happened that transmits a signal communicating the occurrence has happened. At block 805, the product Occurrence Information 222 from product database 85 that is related to the occurrence is checked to see if the occurrence matches any set parameters in the Occurrence Information 222. For instance, all because an event related occurrence is given to the system, does not mean that the occurrence necessarily causes any affect to occur. So if a baseball player goes to bat and hits a single and the occurrence is sent to the system, the baseball players merchandise could possibly not go up in price as only hitting a homerun could cause an affect. If the occurrence parameters are not met, then block 810 occurs where the event related occurrence in relation to the user is dismissed.

If the occurrence meets set parameters for one of the occurrences set for the event, block 815 occurs where relevant users are found by checking any additional parameters set in the relevant occurrence found in Occurrence Information 222 against the relevant user and/or product record. The information utilized for additional parameters can be from the user database 80 or product database 85. For instance, it is possible that if the User Interest/Preference Information 130 shows that the user is interested in the relevant event related product, then the user will be considered as a relevant user. Also the product record can contain information that can determine whether relevant users exist, such as if the product has Sales Restrictions 238 such as alcoholic products will not send any notifications to minors, the User Detail Information 132 will be checked for each user to determine if the user is a minor or not. The relevant users are the users that will be directly affected by the event related occurrence, as it is possible for an event related occurrence to only affect a subset of users.

Once the relevant users are found, the relevant instructions for the event related occurrence are executed as shown in block 825. The instructions, programs, and devices do not need to exist or be executed by the system. The system can point to where instructions exist or utilize other programs and devices to carry out occurrence instructions. Within the system, the instructions for the occurrence can affect the user record in user database 80, the product database 85, or directly transmit information to the portable electronic devices of users. In step 830, the executed instruction affect the information in user database 80 field User Occurrence Information 128, by maintaining a history of what instructions were executed and what was affected. There are various instructions that can be executed from changing the offered quantity of an event related good to sending interactive media to a portable electronic device.

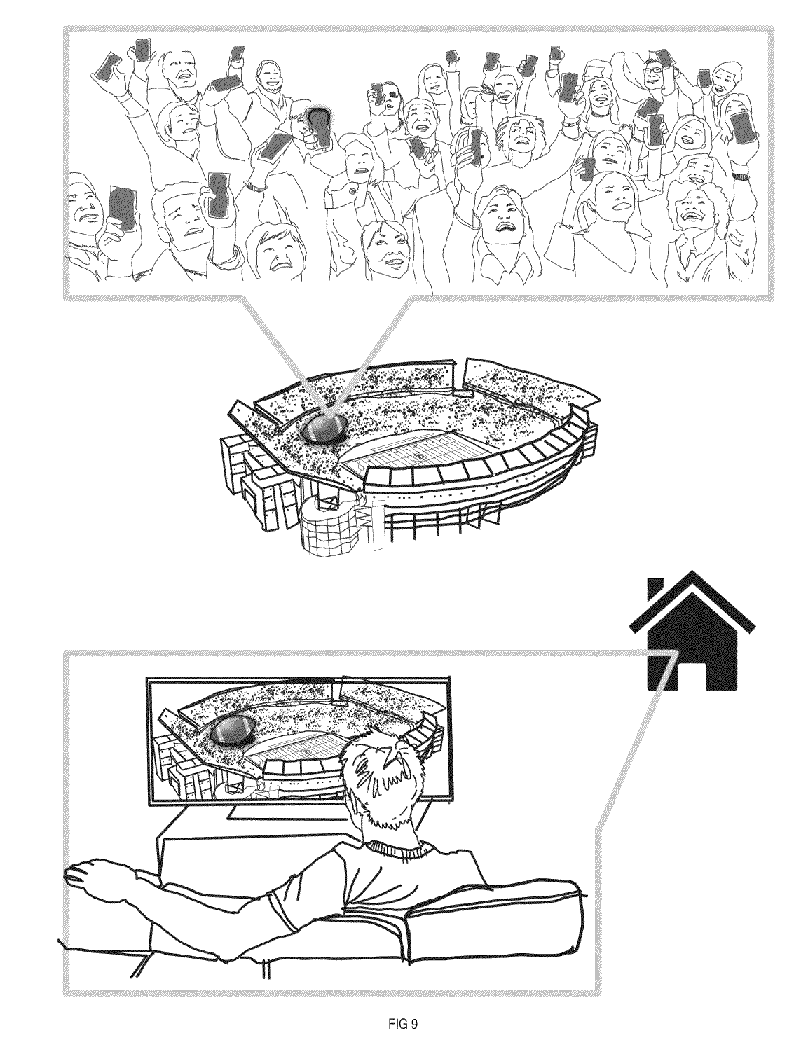

FIG. 9 is an illustration of an embodiment of the invention as a mobile phone application used at a sporting event. FIG. 9 shows two locations, one that is at the sporting venue with attendees holding their portable electronic devices up and the other is at a home of a viewer watching the performance on live television. A larger picture is formed out of the users in an area holding up their portable electronic devices and the screen on each device representing a portion of the larger picture. The image on each device needs to be properly coordinated to form the larger picture; the larger picture is sometimes referred to as a human mosaic and typically done with physical cards that each user holds up. This crowd formed picture can be seen at a distance such as by a viewer at home watching a large pan over the section of the stadium that is participating in creating the picture. Due to the unique nature of various portable electronic devices, it is possible that the picture can seem like it is moving as the images can change in concert on each device. Instead of a static picture, the combined screens from each user device can display a large video image or moving image without users having to physically move or change devices. It is also possible for all the devices to output a sound or a series of sounds and for there to be a user interactive aspect such for all users that participate in forming the picture will be given a gift.

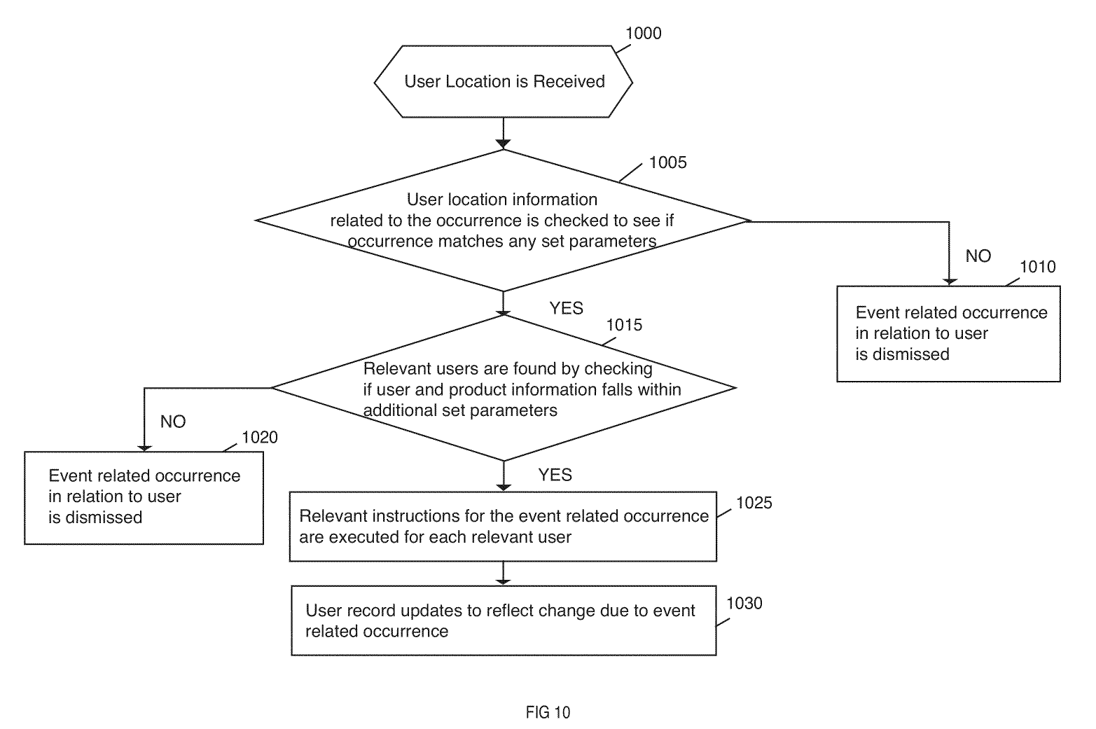

FIG. 10 illustrates the program logic implemented when a user location is received. Block 1000 shows that a user location is received, which can be from either the directly from location data gained from a portable electronic device or a system that determines the user location through APIs (i.e. Foursquare, Facebook, etc.), the user attendee information (i.e. reservation, ticket information, etc.), etc. that transmits a signal communicating the user location. At block 1005, the User Location Information 138 from product database 80 that is related to the user location is checked to see if the user location matches any set parameters in User Location Information 138. For instance, all because a user location is given to the system, does not mean that the user location necessarily causes any affect to occur. So if a user is attending the taping of a television show and the user location is sent to the system, the user location attending the television show could not cause an affect while the user location of a user sitting at home watching the show could cause an effect. If the location parameters are not met, then block 1010 occurs where the event related user location in relation to the user is dismissed.

If the user location meets set parameters for one of the locations set for the event, block 1015 occurs where relevant users are found by checking any additional parameters set in the relevant location found in User Location Information 138 against the relevant user and/or product record. The information utilized for additional parameters can be from the user database 80 or product database 85. For instance, it is possible that if the User Contact Information 116 shows that a user is originally from out of state, the current location of the user can show offers on the best transportation deals back to the user's hometown and the user will be considered as a relevant user. Also the product record can contain information that can determine whether relevant users exist, such as if the product has Sales Information 236 could contain an area where the refund will be accepted, however if the user leaves the area then the refund will no longer be valid. The relevant users are the users that will be directly affected by the user location, as it is possible for an event related user location to only affect a subset of users.

Once the relevant users are found, the relevant instructions for the event related user location are executed as shown in block 1025. The instructions, programs, and devices do not need to exist or be executed by the system. The system can point to where instructions exist or utilize other programs and devices to carry out occurrence instructions. Within the system, the instructions for the user location can affect the user record in user database 80, the product database 85, or directly transmit information to the portable electronic devices of users. In step 1030, the executed instruction affect the information in user database 80 field User Location Information 138, by maintaining a history of what instructions were executed and what was affected. There are various instructions that can be executed from sending information to groups within specific areas to changing the marketed goods and services depending upon the users approaching a vendor.

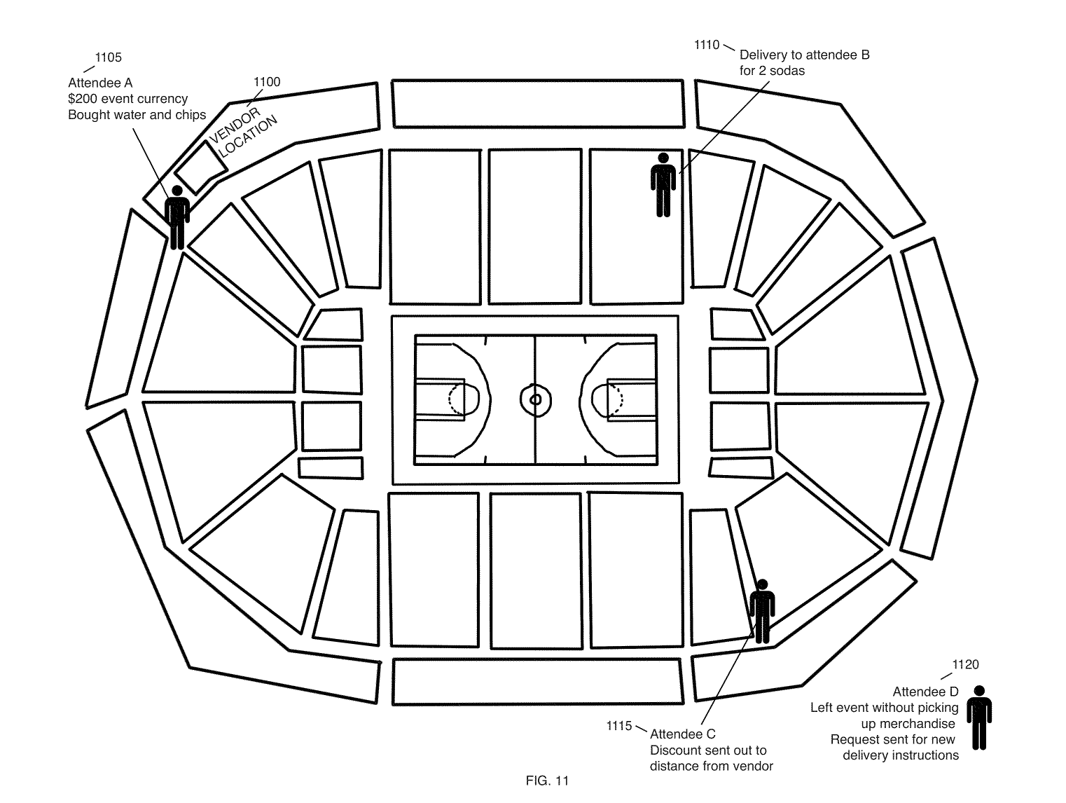

FIG. 11 is an illustration of an embodiment of the invention utilizing event related occurrence, user location, and event currency to show user location over a layout/map of the event and the relevant user current condition or status. The map is based upon the layout of a basketball stadium, however could be any type of map, layout, blueprint of any venue (i.e. shopping mall, performance hall, etc.) The map shows the location of the vendor and event attendees A, B, C, and D that are spread across the map. This map could possibly be accessed and utilized by the vendor at vendor location 1100 to enhance the marketing, buying, and selling of event related goods and services. Attendee A 1105 is passing by the vendor location 1100 and the vendor can be presented with knowing the amount of event currency the user has and the purchasing history of the event attendee showing that the user has bought water and chips. This can allow the vendor to change the marketing of offered products such as by physically moving chips and water to the front of the display as Attendee A 1105 passes by or by changing a digital marketing display to show a discount for chips and water as the user passes by. The system can know the location of Attendee A through geolocation information sent from a portable electronic device that is with Attendee A.

FIG. 11 also shows Attendee B who has already made a purchase of 2 sodas via a portable electronic device using a Paypal account that is accessed through the relevant user record in field Related Account 122. Attendee B's location is found by accessing the seat information on the ticket he/she purchased in the relevant user record in field Purchase History 124. For this product purchase, Attendee B has chosen the delivery method offered from the relevant product record in field Delivery Method 228 that the 2 sodas should be brought to his/her seat within the next 20 minutes. If the sodas are not brought within 20 minutes from the time of purchase, the purchase is automatically refunded to Attendee B. It is possible as seen on FIG. 11 for the system to show where all the event currency is at any given moment whether possessed by vendors or users. It is also possible for the system to show how the event currency was used including any currency trade that was done for event currency.

FIG. 11 also shows Attendee C 1115 who is on the other side of the stadium from vendor location 1100. Attendee C has a preference for massages, which is found in relevant user record in field Interest/Preference 130. The vendor can manually send Attendee C a discount for massages that the vendor at vendor location 1100 offers in order to attract the user across the stadium to travel to the vendor location 1100. It is possible that the offered massage can only be serviced during the last 30 minutes of the event as the vendor at location 1100 sees a decline in business during that time period. The discount could also be only valid if the user pays within the next 10 minutes with event currency only with no refunds allowed. It is possible that a discount for soda is also offered for attendees in this location from the vendor at vendor location 1100. However, the Attendee C has a restriction on event currency usage found in relevant user record in field User Event Currency Information 118 that prevents the user from purchasing soda with event currency, and therefore the discount is not sent to Attendee C.

FIG. 11 also shows Attendee D 1120 who is has currently left the stadium and is now in the parking lot for the event. Attendee D has purchased goods from vendor at vendor location 1100 and requested delivery method of a pickup from the vendor location 1100. However Attendee D has left the stadium without picking up the purchased goods which can be found by geolocation information obtained from a portable electronic device that Attendee D is carrying. It is possible that the sale is not refundable and so Attendee D receives a notification request whether he/she would like to change the delivery method from pickup to deliver to the exit of the parking lot for drive thru pickup or mail to his/her home address obtained from the relevant user record in field user Contact Information 116. It is possible that Attendee D can also either gift the merchandise to another attendee of the event or instruct that another attendee of the event will do the pickup. The attendee that will either receive the gifted merchandise or pickup the merchandise on behalf of Attendee D can receive a notification and then monitored by the system along with the other attendees.

Those skilled in the art will appreciate that alternative embodiments exists from the description herein of the invention or inventions without departing from the spirit and scope of the invention. The invention may be implemented as a method or apparatus, a series of instructions contained in computer-readable media, article of manufacture or a combination thereof, etc., using standard programming and/or engineering techniques to produce software, firmware, hardware, or any combination thereof. The term “article of manufacture” (or alternatively, “computer program product”) as used herein is intended to encompass one or more computer programs and data files accessible from one or more computer-readable devices, carriers, media (i.e. magnetic storage media), “floppy disk”, CD-ROM, cloud storage, a file server providing access to the program via a network transmission line, holographic unit, etc. Of course, those skilled in the art will recognize that many modifications may be made to this configuration without departing from the scope of the invention or inventions.

The invention has been shown in the context of a network system, where all of the communications were performed through the Internet. However, in alternative embodiments, many of the functions can be performed by other means of communication such as telephone, fax, radio, etc.

The invention has been described with respect to the database interface 65 sending notifications, checking event related occurrences, etc. However, in alternative embodiments, some of the functions of the database interface may be implemented in a separate script program or eliminated altogether. Alternatively, the functions shown may be combined or split in any manner amongst one or more systems.

Additionally, the invention has been described with respect to the marketing, buying, and selling of event related products. Event related products can be event related goods or services including event tickets or event currency. As event tickets or event currency can be event related products, they can also occurrence information or location information that affect their sale. For example, event currency can change in value after a specific occurrence or change in value based upon location. Usage of event currency can be an occurrence that affects information in the relevant user record or product record. Events can make all event related product refunds be in event currency or only allow refunds based upon occurrence or user location. A portable electronic device can be used not only in the marketing, buying, and selling of event related products, but also to enhance event related products or the experience with event related products.

Moreover, the invention allows temporary event related goods or services that can be offered due to other event related purchases or occurrences or can be stand-alone offered temporary goods and services. The temporary event related goods and service can retain value within certain time periods, for instance, the current temporary leasing of a location, equipment, etc. can be used as credit to lease other location, equipment, etc. For example, the seat for a venue could be leased until the beginning of the halftime of a football game. However, in the first half of the game other possible seats become available for lease. The user can possibly put his/her current seat up for lease and any profit or loss can be calculated and presented to the user by leasing or buying an alternative seat. Users can possibly be vendors and vendors can possibly be users.

Furthermore, any event related product can have additional achievement information attached to it allowing for a game aspect of “gameification” of event related commerce. For example, there can be different locations that a user needs to physically visit to unlock certain discounts or offers from vendors. Verification that a user has visited these locations can be done by tracking their user location through a portable electronic device, taking pictures of specific locations and submitting them, checking into certain kiosks at each location, etc. Achievements can be done for participating in a “human mosaic” with a portable electronic device. For example, users at home can participate in a poll on which video they want to be seen in a “human mosaic” at the event and by participating in the poll they can be rewarded with an achievement. Users, vendors, or event coordinators can all set a goal for an achievement and the achievement can be a virtual reward or a physical reward due to the user participating in any aspect of the invention.

In addition, the invention has been described in the context of the user and product information being implemented as database records in a database table. However, the user and product information may be implemented in any format for maintaining object information, including spreadsheet, non-database table, etc. Thus, as used herein, the terms database record, database table, and database refer to any data structure known in the art for maintaining information on data objects, such as relational databases, non-relational databases, spreadsheets, ASCII text files, etc.

Therefore, the description herein of embodiments of the invention has been presented for the purposes of illustration and description. It is not intended to be exhaustive or to limit the invention to the precise forms disclosed. Many modifications and variations are possible in light of the above teaching. It is intended that the scope of the invention be limited not by this detailed description, but rather by the claims appended hereto. The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. A computer implemented method stored on a server and accessible over a network or Internet, comprising:
providing a user database implemented on the server including at least one user record, wherein each user record is associated with a user;
creating a user that is associated with the at least one user record;
receiving information of a set event related occurrence that is associated with the at least one user record;
receiving information that the event related occurrence has occurred that is associated with the at least one user record;
executing instructions associated to the event related occurrence information that is associated with the at least one user record;

2. A computer implemented method stored on a server and accessible over a network or Internet, comprising:
providing a product database implemented on the server including at least one product record, wherein each product record is associated with an event related product;
creating an event related product that is associated with the at least one product record;
receiving information of a set event related occurrence that is associated with the at least one product record;
receiving information that the event related occurrence has occurred that is associated with the at least one product record;
executing instructions associated to the event related occurrence information that is associated with the at least one product record;

3. The computer implemented method of claim 1 or 2, wherein the event related product is a good or service related to an event

4. The computer implemented method of claim 1 or 2, wherein a ticket to the event or the event experience is a good or service related to an event

5. The computer implemented method of claim 1 or 2, wherein the event related occurrence involves the event participants

6. The computer implemented method of claim 1 or 2, wherein the event related occurrence involves the event attendees

7. The computer implemented method of claim 1 or 2, wherein the event related occurrence involves the probability of outcome in regards to an event related occurrence

8. The computer implemented method of claim 1 or 2, wherein the event related occurrence involves the stock or inventory of more than one vendor at the event

9. The computer implemented method of claim 1 or 2, wherein the event related occurrence occurs before, during, or after the event

10. The computer implemented method of claim 1 or 2, wherein the information that is sent to the portable electronic devices is time sensitive

11. The computer implemented method of claim 1 or 2, wherein the information that is sent to the portable electronic device causes a visual or audio reaction by the portable electronic device

12. The computer implemented method of claim 1 or 2, wherein the affected information by the occurrence is the price or quantity of an event related good or service

13. A computer implemented method stored on a server and accessible over a network or Internet, comprising:
providing a user database implemented on the server including at least one user record, wherein each user record is associated with a user;
creating a user that is associated with the at least one user record;
receiving information of set location information that is associated with the at least one user record;
receiving information that the user has reached a location that is within the parameters of a set location with the at least one user record;
executing instructions associated to the event related occurrence information that is associated with the at least one user record;

14. The computer implemented method of claim 13, wherein the event related product is a good or service related to an event

15. The computer implemented method of claim 13, wherein a ticket to the event or the event experience is a good or service related to an event

16. The computer implemented method of claim 13, wherein the user location is within or outside the event

17. The computer implemented method of claim 13, wherein the user location is utilized in the delivery of a good or service

18. The computer implemented method of claim 13, wherein the user location is utilized in the event related marketing presented to the user

19. A computer implemented method stored on a server and accessible over a network or Internet, comprising:
providing a user database implemented on the server including at least one user record, wherein each user record is associated with a user;
creating an event currency that can be used to make an event related purchase that is associated with the at least one user record;
allowing user access to relevant user event currency to make an event related purchase that is associated with the at least one user record;
updating the user event currency after a transaction related to the at least one user record.

20. The computer implemented method of claim 19, wherein the event related currency is a budget for event related purchases

21. The computer implemented method of claim 19, wherein the event related currency is a new currency name related to the name of the event or participants of the event

22. The computer implemented method of claim 19, wherein the event related currency is transferred to other users

23. The computer implemented method of claim 19, wherein the event related currency for a user is administrated by another user

24. The computer implemented method of claim 19, wherein the event related currency is restricted to certain goods and services

25. The computer implemented method of claim 19, wherein the event related currency is purchased at a discount

26. The computer implemented method of claim 19, wherein the event related currency value changes over time

27. The computer implemented method of claim 19, wherein the event related currency value changes due to user location

28. The computer implemented method of claim 19, wherein the event related currency value changes due to usage of event related currency

29. The computer implemented method of claim 19, wherein transactions of event related currency allows an event related benefit

30. The computer implemented method of claim 19, wherein a refund or credit is transacted or given with event related currency

31. The computer implemented method of claim 19, wherein the event currency is accepted at more than one event
